(19) United States
(12) Patent Application Publication
(10) Pub. No.: US 2012/0030886 A1
(43) Pub. Date: Feb. 9, 2012

(54) Device for an extendable reception of a ramp

(75) Inventors: Martin Persson, Sjobo (SE); Anders Hammer, Sjobo (SE); Jan-Erik Hernvall, Sjobo (SE)

(73) Assignee: Hubner Transportation GmbH, Kassel (DE)

(21) Appl. No.: 13/118,698

(22) Filed: May 31, 2011

(30) Foreign Application Priority Data
May 31, 2010 (EP) EP10005640.7
Jul. 8, 2010 (EP) EP10007038.2

(51) Int. Cl. B60P 1/43

(52) U.S. Cl. 14/71.1

(57) ABSTRACT

Subject matter of the invention is a device for an extendable reception of a ramp, wherein the device can be mounted at a vehicle in the area of the vehicle door, wherein the device comprises a drive assembly for the ramp, wherein the drive assembly comprises a slide, wherein the slide is connected with the ramp, wherein the drive equipment can be engaged with at least one power transmission element mounted at the vehicle.

The invention concerns a device for an extendable reception of a ramp, wherein the device can be mounted to a vehicle in the area of the vehicle door, wherein the device comprises a drive equipment for the ramp, wherein the drive equipment comprises a slide, wherein the slide is connected with the ramp, wherein the drive equipment can be engaged with at least one power transmission element arranged at the vehicle.

Ramps that can be mounted in the area of the vehicle door, for example of a bus, are well documented in prior art. Especially known are so-called ramps that are opened manually, for example, to make it easier for a wheelchair user to enter a vehicle for public transportation, in particular, a bus (EP 1 837 233 A1). In addition, motor-operated ramps are known which are provided on both sides of the ramp platform with so-called ramp wagons which are moved by means of spindles in order to be able to adjust the platform. The spindles, in turn, are motor-driven (DE 10 043 561). Such ramps are mounted directly underneath the vehicle floor, for example of a bus. However, it is also known to mount these ramps, which are placed in a cassette to protect them from moisture and contamination, in a recess underneath the door sill of the vehicle instead of simply mounting them underneath the vehicle floor.

In this context, EP 1 747 939 discloses a motor-operated ramp in which two belt-driven spindles situated in parallel in a cassette are moved by means of a drive motor, each spindle being connected with the belt drive by means of a spindle nut. The drive mechanism is located at the rear end of the ramp and cannot be accessed from the outside without removing the entire device.

It is known that especially in winter the ramp is exposed to heavy contamination. This is especially the case because large amounts of snow and ice, as well as salt and grit seep into the interior of the ramp and, consequently, into the cassette when the ramp is used, resulting in the fact that frequently a mixture of salt and grit accumulates in the area of the drive equipment. This causes the drive mechanism to malfunction which often results in damages to the drive motor. Because of the moisture, it is also possible that the electrical control system of the drive equipment is damaged. Currently when such damage occurs, the entire device for receiving the ramp, i.e., the entire cassette in which the ramp is located, has to be removed in order to repair the drive mechanism. This is very time-consuming and expensive.

Therefore it is the objective of the invention to facilitate the maintenance and, if required, the repair of an extendable ramp.

To achieve this objective, the invention proposes that the drive equipment comprises a drive motor arranged on a slide wherein the slide is connected with the ramp.

The drive equipment is connected with the ramp. Furthermore, the drive equipment can be engaged or disengaged with the power transmission element. In the event that the drive equipment is not engaged with the power transmission element it is possible to disengage any arresters at the front region of the device and remove the ramp including drive equipment from the device and, if required, replace it with an exchange ramp. Consequently, it is not necessary to remove the entire device, especially the cassette which houses the ramp and drive equipment. This is especially of advantage in a case in which the cassette is mounted underneath the vehicle floor in the area of the vehicle door because in order to remove the cassette it is necessary to move the vehicle over a pit room since otherwise the cassette cannot be accessed.

Advantageous characteristics and embodiments of the invention are disclosed in the sub-claims.

In particular, provision has been made that the drive motor of the drive equipment is connected with at least one power transmission element. As a result, there is a direct connection between the drive motor and the power transmission element, wherein especially when the at least one power transmission element is designed as a gear rod, the drive motor can be engaged with the gear rod by means of a respective gear pinion.

To make sure that the ramp does not get jammed when extended, preferably two power transmission elements running parallel to each other and comprising in particular gear rods running parallel to each other are provided at the vehicle, wherein the drive motor is connected with both power transmission elements, wherein in this context the gear pinion that is connected with the first gear rod preferably comprises a spindle, wherein the spindle comprises an additional gear pinion which is connected with the second bear rod.

As shown above, in order to make it easier to install the device, provision has been made to house the device in a cassette, wherein the ramp and the drive equipment are arranged inside the cassette, wherein when installed the cassette comprises a cover plate covering the ramp and the at least one gear rod is attached to the cover plate. As a result, the gear rod, or generally speaking the power transmission element, is not directly connected with the vehicle but only indirectly by means of the cover plate mentioned above. In order to protect the components arranged in the cassette it is intended that the cassette preferably comprises a base plate which allows for the device to be mounted as one unit. Furthermore, it is intended that the cassette comprises sidewalls longitudinally to the direction of extension of the ramp, wherein the sidewalls comprise grooves in longitudinal direction to the guided reception of the ramp.

At the front end of the cassette, an arrester has been provided on each side of the cassette, which arresters prevent the ramp, including the slide, from being accidentally completely extracted from or pulled out of the cassette. The arresters can be disengaged, which results in the fact that after disengaging the arresters the ramp including the drive equipment can be extracted, for example, for the purpose of exchanging the ramp. To make it easier to disengage the arresters from the cassette, for example, in order to quickly exchange of the ramp, the invention provides the especially advantageous characteristic that the arrester is displaceable by means of a groove guide laterally to the direction of extension of the ramp. A pressure piece in the groove guide has been provided to arrest the arrester. Such a pressure piece comprises a spring-loaded ball arranged in a shell. At the end facing the arrester, the shell comprises an inward-looking projection which prevents the ball from protruding out of the shell beyond its median. The arrester has a respective shell-shaped recess corresponding to the shape of the ball. Consequently, in order to disengage the arrester, it is merely required to pull the arrester out of the groove guide against the force of the spring-loaded ball. This does not require any special tools.

As mentioned above, the ramp can be arrested when retracted so as to prevent an accidental extension of the ramp. Preferably, the device comprises a locking device for the ramp. In particular, the locking device comprises a bolt which can be arranged on the slide, wherein the bolt can be engaged with a fixed part of the device and, in this case, especially with the power transmission element, advantageously, however, with the gear rod. Furthermore, the locking device comprises an unlocking member, wherein the bolt can be moved by the unlocking member, advantageously in the sense that the bolt can be disengaged from the power transmission element and, in this case, particularly from the gear rod. Advantageously, the unlocking member is designed as a rod which extends to the front end of the cassette. This clearly shows that the unlocking member can be grabbed manually when the pivotable flap attached at the front end of the cassette is opened. By pulling the unlocking member designed as a rod, the bolt is disengaged from the gear rod. Subsequently, after removing the arresters, it is possible to extract the ramp including the slide on which the drive motor with the electrical control is located.

As previously mentioned, it is necessary to make sure that the ramp does not accidentally roll out when it is retracted. For this purpose, the ramp is arrested by means of a bolt (see above) which has been arranged on the slide and which can be engaged, for example, with the gear rod. In order to avoid having to unlock the ramp manually, a further characteristic of the invention provides that the unlocking member is designed as a motorized drive which is connected with the bolt, wherein the bolt can be disengaged from the gear rod when the motorized drive is activated.

The ramp is connected with the slide by means of a hinge. As a result, the ramp can fold down when it is extended.

To make sure that in extended condition of the ramp no ledge is formed between the ramp and the floor of the vehicle, for example a bus, the ramp has on its rear end in the area where the slide is attached to the ramp at least one, preferably two elbow levers which are arranged on both sides of the ramp. These elbow levers interact with the arresters arranged at the front end of the cassette in such a way that the elbow levers pivot when the elbow levers impact the arrester and the ramp swings upward at the rear end, the end that is directly adjacent to the cassette or the floor of the vehicle. At the same time, the elbow levers form a connection between the ramp, on the one hand, and the slide, on the other hand, wherein the elbow levers form the hinge-like connection between ramp and slide.

Subsequently, the invention is explained in more detail by means of the following drawings.

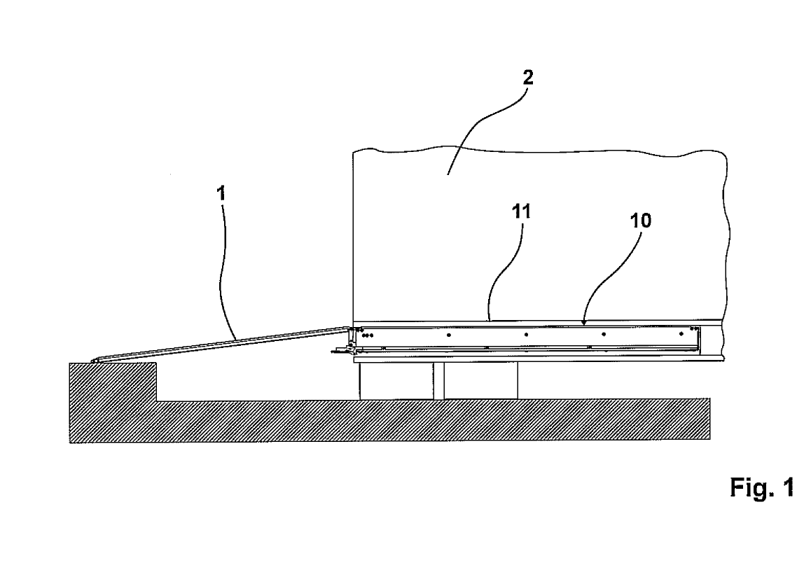

FIG. 1 provides a schematic view of a vehicle with a device for receiving a ramp, wherein the ramp is shown in extended condition;

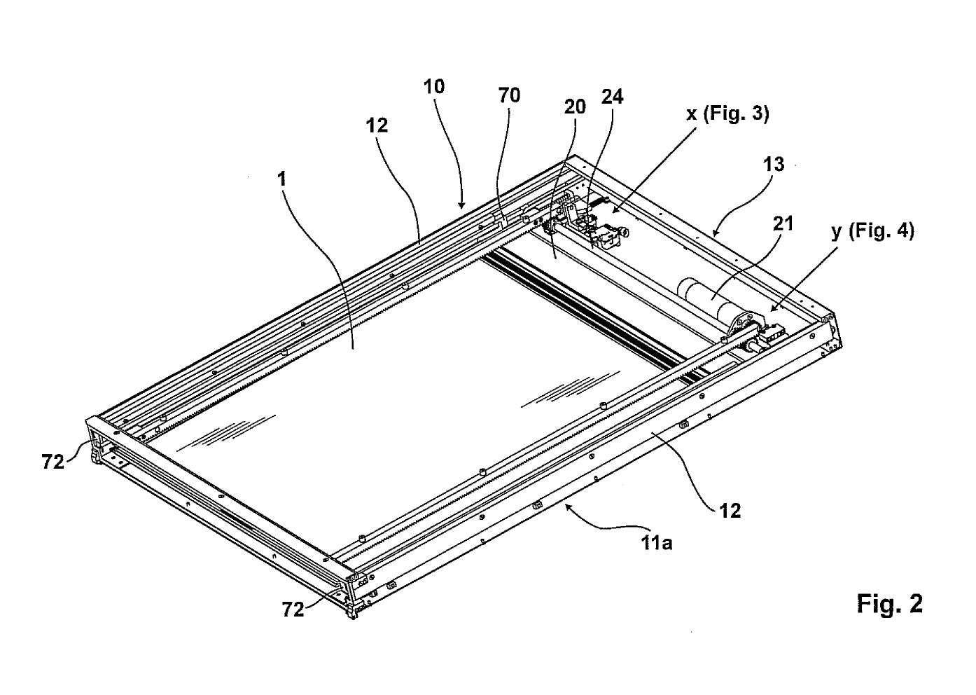

FIG. 2 provides a perspective top view of the device for an extendable reception of a ramp, wherein the cover plate of the cassette has been omitted;

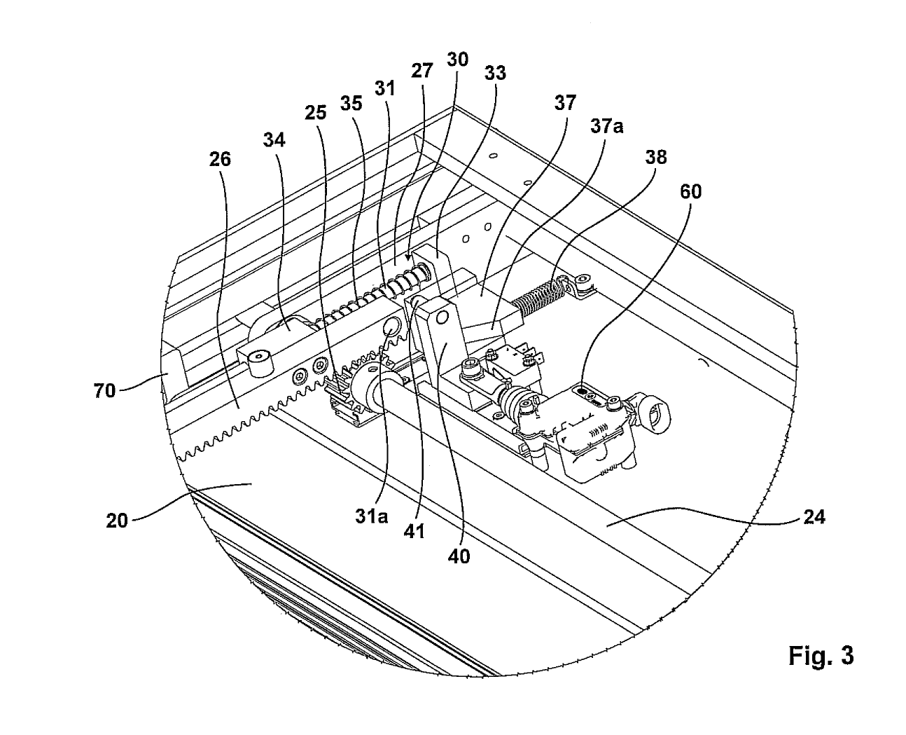

FIG. 3 shows an enlarged view of the detail x;

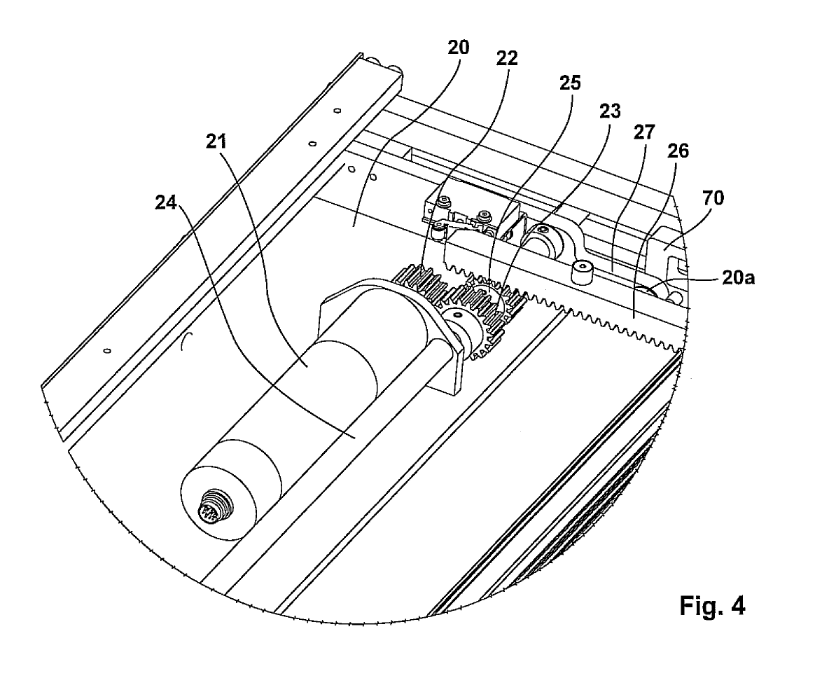

FIG. 4 shows an enlarged view of the detail y;

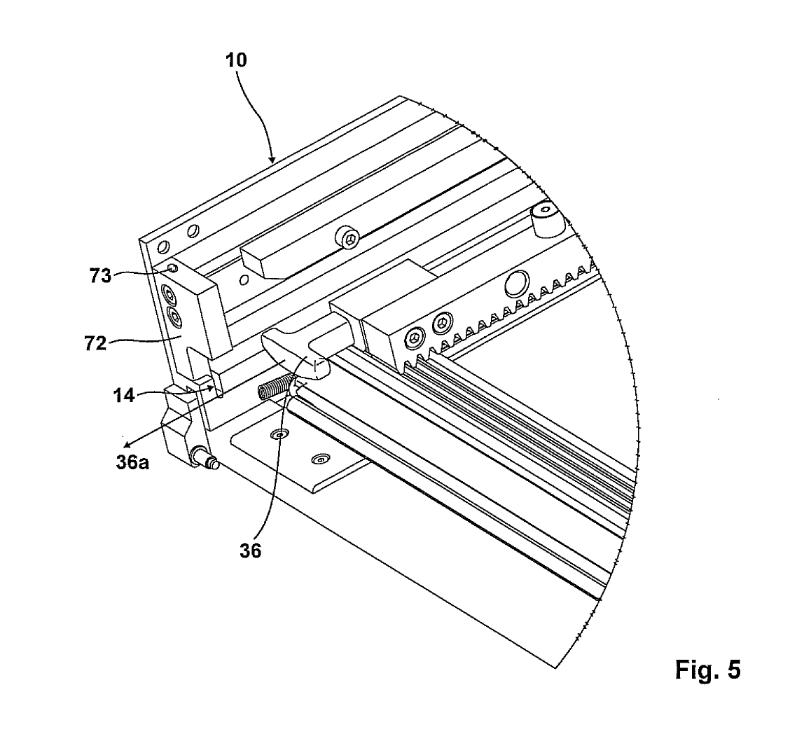

FIG. 5 shows the front end of the device with the ramp in retracted condition, wherein the rod-like unlocking member is visible;

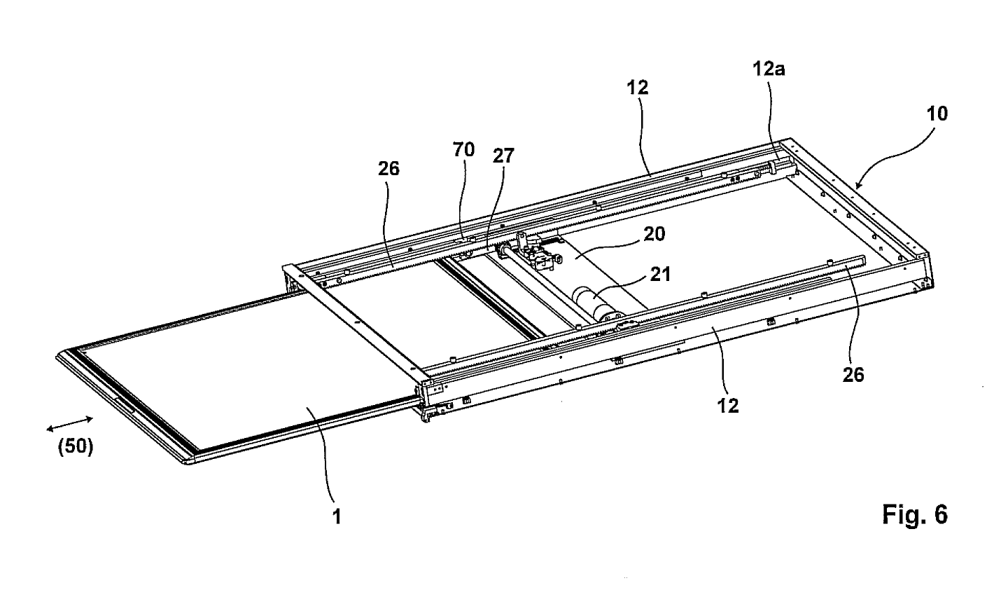

FIG. 6 shows a representation according to FIG. 2, wherein the ramp is shown in partially extended condition;

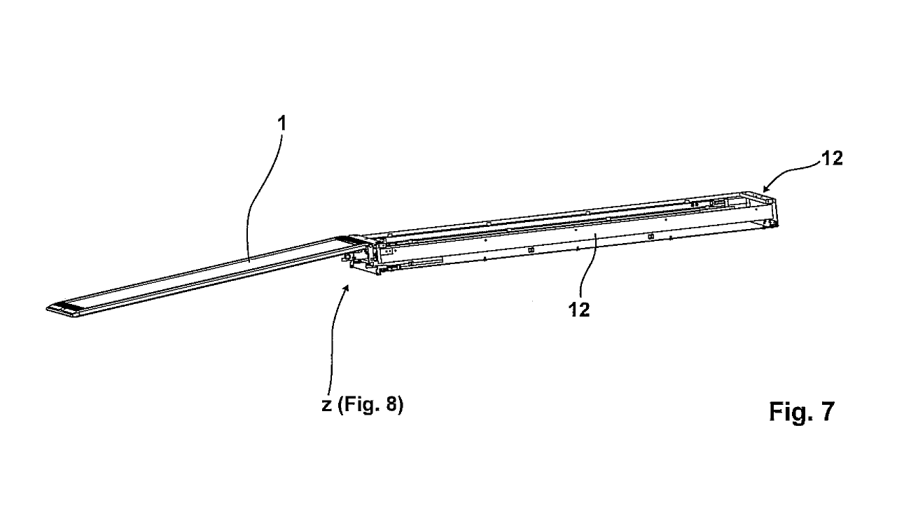

FIG. 7 shows a representation according to FIG. 6, wherein the ramp is shown in completely extended and lifted condition;

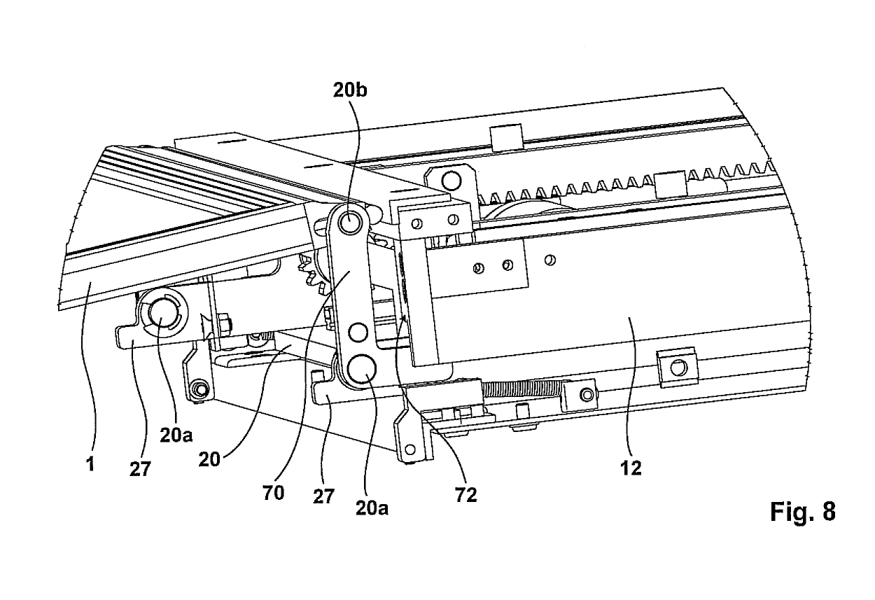

FIG. 8 shows an enlarged representation of the detail shown in FIG. 7;

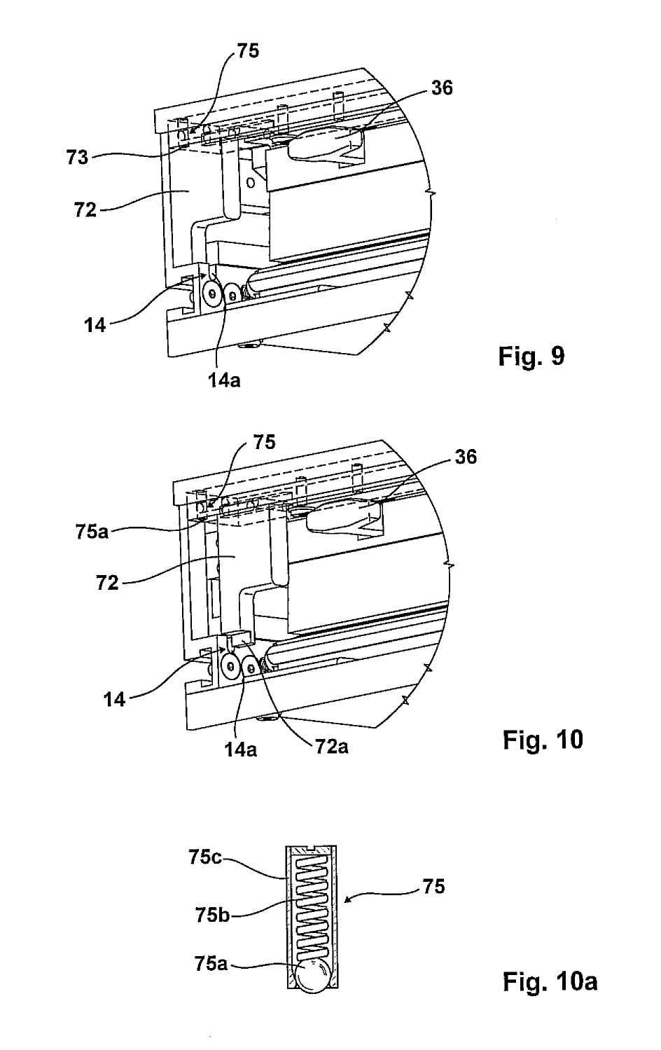

FIG. 9 shows the arrangement of the arrester in the cassette in arrested condition;

FIG. 10 shows the arrester in disengaged condition;

FIG. 10a shows the pressure piece.

The vehicle 2 schematically shown in FIG. 1 has a recess in the area of the vehicle door for receiving the cassette 10 which, in turn, is receiving the ramp 1. Here the cassette 10 has a cover plate 11 which forms the floor of the vehicle or which is located underneath the floor of the vehicle. By means of FIGS. 2 ff, the cassette 10 is described in more detail. The cassette 10 comprises two sidewalls 12 and a rear wall 13. The rear wall 13, as well as the sidewalls 12 form together with the cover plate 11 (FIG. 1) and a base plate 11a the cassette 10 mentioned above. The sidewalls have longitudinal grooves 12a in which according to the double arrow 50 the ramp 1 is guided parallel to the direction of extension (FIG. 6). By means of two elbow levers 70, the ramp 1 is flexibly connected with the slide 20 (FIG. 8), wherein the elbow lever and the bracket 27 form the connection between slide and ramp. On the slide 20 the electrical drive motor 21 is located, wherein the drive motor 21 has a drive pinion 22 (shown in FIG. 4) which meshes with a transmission pinion 23 which, in turn, is arranged on a spindle 24 which has on one end the gear pinion 25 that meshes with the gear rod 26. On its opposite end, the spindle 24 has also a gear pinion 25 (FIG. 3) which is engaged there with the second gear rod 26. The two gear rods 26 running parallel to each other are fixed, i.e., they are connected with the cover plate 11 of the cassette 10. Consequently, when the drive motor 21 is operated, the slide 20 moves along the two gear rods. Since the slide 20 is also connected with the ramp 1 through the brackets 27 and elbow levers 70 arranged on both sides (FIG. 3, FIG. 4), the ramp 1 and the slide 20 are extended in the direction of the double arrow 50 when the drive motor 21 is activated. In this context, reference is made to FIG. 6 which clearly shows the position of the slide 20 in the case of a partially extended ramp 1.

Here, the elbow levers are arranged on both sides of the ramp and are flexibly connected with the ramp 1 and the slide 20 (FIG. 8).

Part of the subject matter of the invention is also the locking device 30. The locking device 30 comprises the locking rod 31 (FIG. 3) which has at its end the locking support 33. The locking rod 31 is mounted in the bearing bracket 34 which is arranged at the gear rod 26. Between the bearing bracket 34 and the locking support 34 a compression spring 35 is located. When the handle bar 36 (FIG. 5) is pulled through the locking support 33 in the direction of the arrow 36a, the locking piece 37 is also pulled against the force of the spring 38 in the direction of the arrow 36a, wherein the locking piece has an oblique surface 37a which rests against the bolt 40. The bolt 40 has a locking pin 41 which can be engaged with a respective drill hole 31a of the gear rod 26. When the locking piece 37 is displaced in the direction of the arrow 36a, the bolt 40 is disengaged from the drill hole 31a in the gear rod. As a result, after such manual unlocking, the ramp 1 including the slide 20 can be pulled out of the cassette 10. This can take place provided the arresters 72 have been removed which are arranged at the front end on both sides of the cassette. As shown in FIGS. 9 to 10a, a spring-loaded pressure piece 75 has been provided in the cassette 10 in the cover plate 11. The spring-loaded pressure piece 75 comprises a shell 75c which includes the ball 75a loaded by a spring 75b. On its surface the arrester 72 has a shell-like recess 73 for the ball 75a of the pressure piece. The arrester 72 is retained by means of a groove guide 14 which runs laterally to the direction of extension. In particular, the cassette has a groove 14a and the arrester 72 a spring 72a, wherein the spring 72a engages in the groove 14a (FIG. 9, FIG. 10). When the two arresters 72 on both sides of the ramp are removed, it is possible to extract the ramp together with the slide and, if required, replace it with a different ramp.

As previously described, the locking rod 31 makes it possible to manually unlock the device, which is necessary if the slide and the drive equipment located on the slide have to be accessed for maintenance or repair purposes. For normal operation, an electric motor 60 is provided which is connected with the bolt 40, wherein the bolt 40 with the twistlock 41 is also disengaged from the drill hole 31a in the gear rod 26.

As shown in FIG. 2 and FIG. 8, an elbow lever 70 is mounted to the ramp 1. As shown in detail in FIG. 8, the elbow lever 70 is connected by means of a hinge 20a with the slide 20 and by means of a hinge 20b with the ramp 1. When, as shown in FIG. 2, the elbow lever 70 moves in lying position against the arrester 72 arranged at the front end of the cassette, the elbow lever pivots into the position shown in FIG. 8 and, because it is connected with its other end with the ramp, the elbow lever raises the ramp 1 up. As a result, the ramp allows for a smooth transition from the ramp to the inside of the vehicle.

1. Device for an extendable reception of a ramp, wherein the device is configured to be mounted on a vehicle in the area of the vehicle door, said the device comprising: a drive assembly for the ramp, wherein the drive assembly comprises a slide, wherein the slide is connected with the ramp, wherein the drive assembly is engageable with at least one power transmission element arranged at the vehicle, wherein the drive assembly further comprises a drive motor arranged on the slide, and wherein the slide is connected with the ramp.

2. Device according to claim 1, wherein the drive motor of the drive assembly is connected with at least one power transmission element.

3. Device according to claim 1, wherein the at least one power transmission element is a gear rod, and wherein the drive motor is connected with the gear rod by means of at least one gear pinion.

4. Device according to claim 1, wherein two power transmission elements running parallel to each other are provided at the vehicle, and wherein the drive motor is connected with both power transmission elements.

5. Device according to claim 1, wherein two gear rods running parallel to each other are provided at the vehicle, wherein the drive motor is connected with a first gear rod by means of a gear pinion, and wherein the gear pinion comprises a spindle, and wherein the spindle has a further gear pinion which is engaged with the second gear rod.

6. Device according to claim 1, wherein the device comprises a cassette, wherein the ramp and the drive assembly are arranged in the cassette, wherein the cassette when installed comprises a cover plate covering the ramp and wherein the at least one gear rod is attached to the cover plate.

7. Device according to claim 1, wherein the cassette has a base plate.

8. Device according to claim 1, wherein the cassette comprises sidewalls running longitudinally to the direction of extension of the ramp, and wherein the sidewalls comprise grooves running in a longitudinal direction to the guided reception of the ramp.

9. Device according to claim 1, wherein the device includes a locking device for the ramp.

10. Device according to claim 9, wherein the locking device comprises a bolt which can be arranged on the slide, wherein the bolt can be engaged with a fixed part of the device.

11. Device according to claim 10, wherein the bolt can be engaged with the power transmission element.

12. Device according to claim 10, wherein the locking device has an unlocking member, and wherein the bolt can be displaced by means of the unlocking member.

13. Device according to claim 12, wherein the unlocking member is a rod which extends to the front end of a cassette which retains the ramp and drive assembly.

14. Device according to claim 12, wherein the unlocking member is a motorized drive which is connected with the bolt.

15. Device according to claim 1, wherein the drive motor for the ramp is arranged on the slide.

16. Device according to claim 1, wherein the ramp is connected with the slide by means of a hinge.

17. Device according to claim 1, wherein the ramp has at least one elbow lever at the rear end of the ramp, and that the elbow lever interacts with an arrester arranged at the front end of the cassette so that the elbow lever pivots when the elbow lever impacts the arrester and the ramp swings upward at the rear end.

18. Device according to claim 17, wherein the arrester is retained in the cassette by means of a groove guide which runs laterally to the direction of extension of the ramp.

19. Device according to claim 18, further including a spring-loaded pressure piece which operates to lock the arrester in the cassette.
